(19) United States
(12) Patent Application Publication
(10) Pub. No.: US 2008/0040092 A1
(43) Pub. Date: Feb. 14, 2008

(54) Information processing apparatus and method

(75) Inventor: Akihiko Kimura, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/827,107

(22) Filed: Jul. 10, 2007

(30) Foreign Application Priority Data
Jul. 13, 2006 (JP) JP2006-192661

(51) Int. Cl. G06F 9/45

(52) U.S. Cl. 703/22

(57) ABSTRACT

An information processing apparatus includes: a plurality of circuit blocks including processor blocks; a software block accommodating and executing programs for executing software; and an integrated control block performing integrated control of the whole system. The processor block fetches execution code from the software block for simulating software, via message passing communications, and executes simulation in accordance with the execution code. The integrated control block controls in such a manner that a node executing simulation of the software block dynamically activates and deactivates simulation code as necessity arises; when new software is to be activated, the integrated control block controls to check whether another software has already been executed; if the other software is under execution, the integrated control block copies a simulation environment of a hardware block, connects the new software block to the copied simulation environment of the hardware block, and starts simulation.

### BACKGROUND OF THE INVENTION

1. Field of the Invention

The present invention relates to an information processing apparatus and a method thereof, and more particularly to technology for management and control of a system which performs logical simulation of software and hardware flexibly and at high speed, in a development, design and execution environments for a semiconductor device including a processor block.

2. Description of Related Art

Generally, a supply of an execution program of a processor contained in hardware for a simulation environment is included in simulation code in advance, and integrated execution is performed during simulation execution including pseudo execution of software (e.g., see Japanese Patent Application Publication No. 2000-76211 (Patent Document 1)).

Japanese Patent Application Publication No. 2000-011022 (Patent Document 2) describes a technique regarding a simulation method involving a software block and a hardware block, and provides the content focused on a simulation method itself for a processor block which executes software.

In this technique, the simulation method for a processor block dynamically switches between a simulation with instruction model and a cycle accurate simulation under certain conditions.

More specifically, a plurality of types of processor simulation models and a logical circuit model are prepared beforehand, and the processor simulation models are dynamically switched during simulation execution to perform simulation, including branch, exceptional process and the like, of mutual operations of the processor block and logical circuit block.

Japanese Patent Application Publication No. HEI-09-293002 (Patent Document 3) describes a system in which a target electronic system combining elements operating both hardware and execution software is simulated partially by physical simulation and partially by conceptual software simulation.

### SUMMARY OF THE INVENTION

However, it is difficult for the technique disclosed in Patent Document 1 to perform flexible simulation when simulation of software containing new debug software is to be executed, when simulation is to be executed again by entering a change obtained definitely from the result of already executed simulation, and in other cases. Depending upon restrictions of an execution environment, additional simulation and re-execution simulation are required to wait for the completion of execution of the initial simulation, thereby considerably hindering a reduction in a design turnaround time (TAT).

The technique described in Patent Document 2 or 3 may pose an issue such that, when hardware including a processor block and software are to be simulated in a semiconductor device development/design environment using Electronic Design Automation (EDA), it is difficult to realize dynamic simulation.

Accordingly it is desirable to provide an information processing apparatus and method capable of providing a flexible development environment for controlling dynamically a simulation execution environment for simulation of hardware including a processor block and software, and improving a development efficiency. The present invention is made in view of the above.

According to the first aspect of the present invention, there is provided an information processing apparatus for performing information processing in a cooperative simulation execution environment for executing simulation of hardware and software by processing each block on a different processor. The information processing apparatus includes: a plurality of circuit blocks including processor blocks; a software block accommodating and executing programs for executing software; and an integrated control block performing integrated control of the whole system. The processor block fetches execution code from the software block for simulating software, via message passing communications, and executes simulation in accordance with the execution code. The integrated control block controls in such a manner that a node executing simulation of the software block dynamically activates and deactivates simulation code as necessity arises; when new software is to be activated, the integrated control block controls to check whether another software has already been executed; if the other software is under execution, the integrated control block copies a simulation environment of a hardware block, connects the new software block to the copied simulation environment of the hardware block, and starts simulation.

The integrated control block may perform copy and termination control of a simulation system at a repetition frequency corresponding to the number of activations, for the hardware block other than the software block.

According to the second aspect of the present invention, there is provided an information processing apparatus for performing information processing in a cooperative simulation execution environment for executing simulation of hardware and software by processing each block on a different processor. The information processing apparatus includes: a plurality of circuit blocks including processor blocks; a software block accommodating and executing programs for executing software; and an integrated control block performing integrated control of the whole system. A node executing simulation of the processor block receives, via message passing communications, command code of execution program from a process executed at a node executing simulation of the software block. The integrated control block: dynamically controls and manages a configuration of the execution environment in accordance with a state of resources of the cooperative simulation execution environment and execution content of the software block; if content of a software block to be activated while a first simulation of another software block is being executed is different from the other software block, designates a configuration formed with a copy block obtained by copying a plurality of circuit blocks including processor blocks and its own software block and another node as simulation resources, and executes a second simulation at the another node of the system. If the content of the software block to be activated while the first simulation of the other software block is being executed is content following the content of the other software block, controls to monitor an execution state of the other software block, and when an execution completion is detected, executes the second simulation of its own software block.

According to the third aspect of the present invention, there is provided an information processing method of performing information processing in an cooperative simulation execution environment for executing simulation of hardware and software by processing each block on a different processor, by using a plurality of circuit blocks including processor blocks and a software block accommodating and executing programs for executing software. The information processing method includes: executing simulation in accordance with execution code obtained by fetching the execution code from the software block for simulating software, via message passing communications, by the processor block; controlling a node for executing simulation of the software block so as to dynamically activate and deactivate simulation code as necessity arises; checking whether another software has already been executed if new software is to be activate; copying a simulation environment of a hardware block if the other software is under execution; and starting simulation by connecting the new software block to the copied simulation environment of the hardware block.

According to the fourth aspect of the present invention, there is provided an information processing method of performing information processing in a cooperative simulation execution environment for executing simulation of hardware and software by processing each block on a different processor, by using a plurality of circuit blocks including processor blocks and a software block accommodating and executing programs for executing software. The information processing method includes: receiving, by a node for executing simulation of the processor block, command code of execution program from a process executed at a second node for executing simulation of the software block, via message passing communications; dynamically controlling and managing a configuration of the execution environment in accordance with a state of resources of the cooperative simulation execution environment and execution content of the software block; designating a configuration formed with a copy block obtained by copying a plurality of circuit blocks including processor blocks and its own software block, and another node as simulation resources, if content of a software block to be activated while a first simulation of another software block is being executed is different from the other software block; executing a second simulation at the another node of the system; and monitoring an execution state of the other software block and executing the second simulation of its own software block upon detection of an execution completion if the content of the software block to be activated while the first simulation of the other software block is being executed is content following the content of the other software block.

The present invention has an advantage in that it is possible to provide a flexible development environment for controlling dynamically a simulation execution environment for simulation of hardware including a processor block and software, and to improve a development efficiency.

### BRIEF DESCRIPTION OF THE DRAWINGS

FIG. 1 is a system configuration diagram illustrating a basic concept of an information processing apparatus according to an embodiment of the present invention;

FIG. 2 is a diagram showing a concrete architecture of main parts of an information processing apparatus according to an embodiment of the present invention;

FIG. 3 is a flow chart illustrating procedure of execution file generation by a software block;

FIG. 4 is a flow chart illustrating procedure of execution environment activation by software block;

FIG. 5 is a block diagram showing an example of structure of a first node in each block excepting a storage system;

FIG. 6 is a block diagram showing an example of structure of a second node in the storage apparatus;

FIG. 7 is a diagram illustrating data communications between two nodes (hardware) via a network by using a generated execution file;

FIG. 8 is a diagram illustrating data communications between two nodes (hardware) via a shared memory by using a generated execution file;

FIG. 9 is a diagram showing an example of a typical sequence to be executed by a system of an embodiment of the present invention;

FIG. 10 is a flow chart illustrating a software activation termination control procedure by an integrated control block when a new software block is to be activated;

FIG. 11 is a flow chart illustrating a software activation termination control procedure by an integrated control block when another scenario is to be added after a software block has been activated;

FIG. 12 is a diagram showing an example of structure of a hardware block and a software block for an initial scenario; and

FIG. 13 is a diagram showing an example of structure of a software block for an additional scenario.

### DETAILED DESCRIPTION OF EMBODIMENTS

An embodiment of the present invention will now be described with reference to the accompanying drawings.

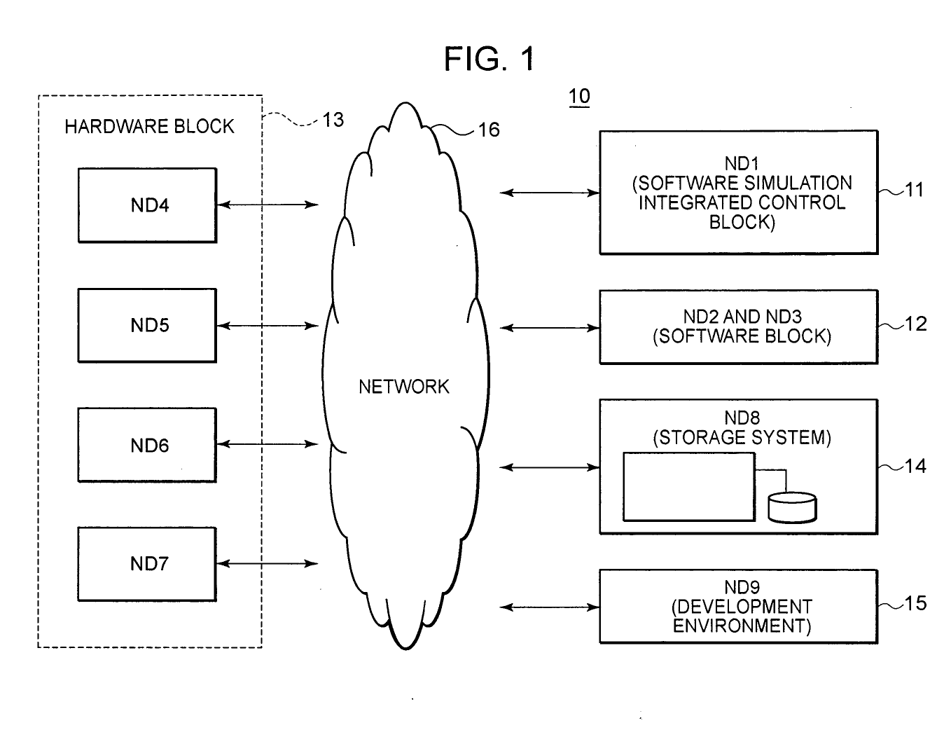

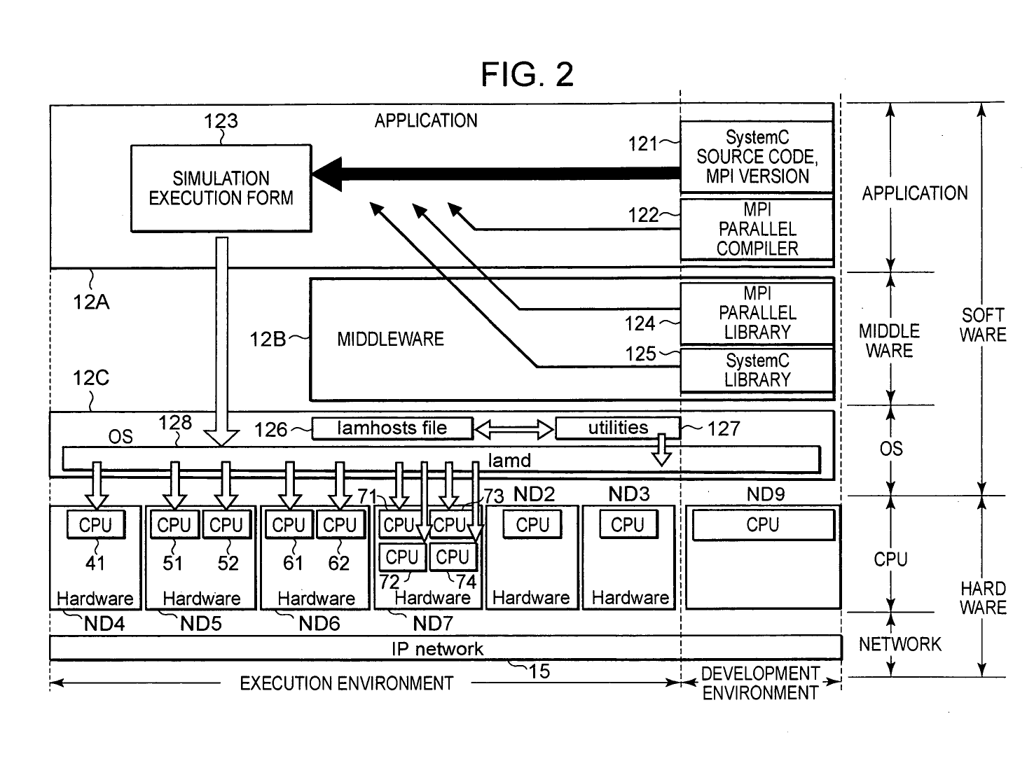

FIG. 1 is a system configuration diagram illustrating a basic concept of an information processing apparatus according to the present embodiment. FIG. 2 is a diagram showing a concrete architecture of a main part of the information processing apparatus.

As shown in FIG. 1, the information processing apparatus 10 connects a software simulation integrated control block (hereinafter called simply an integrated control block) 11 including a node ND1, a software block 12 including nodes ND2 and ND3, a hardware block 13 including a plurality of nodes ND4 to ND7 (in this embodiment, four nodes), a storage apparatus 14 including a node ND8, and a network 16 to which the integrated control block 11, the software block 12, the hardware block 13, the storage apparatus 14 and a development environment 16 including a node ND9 are connected for mutual communications therebetween.

The integrated control block 11 conducts an integrated control of the whole system, and dynamically controls and manages the configuration of a cooperative simulation execution environment, in accordance with the state of resources of the execution environment and execution contents of software blocks.

The development environment 15 including the node ND9 shown in FIGS. 1 and 2 is a computer environment in which source code of SystemC of an MPI version is compiled by an MPI parallel compiler to generate a file of a simulation execution form.

The software block 12 accommodates and executes programs for executing software. For example, as shown in FIG. 2, the software block 12 is constituted of an application part 12A, a middleware part 12B and an operating system (OS) 12C.

The application part 12A includes a SystemC source code (MPI version) generation part 121, an MPI parallel compiler 122 and a simulation execution form part 123. The middleware part 12B includes an MPI parallel (function) library 124 and a SystemC library 125. The operating system 12C includes a LAM host file part 126, a utility part 127 and a resident program part (lamd) 128.

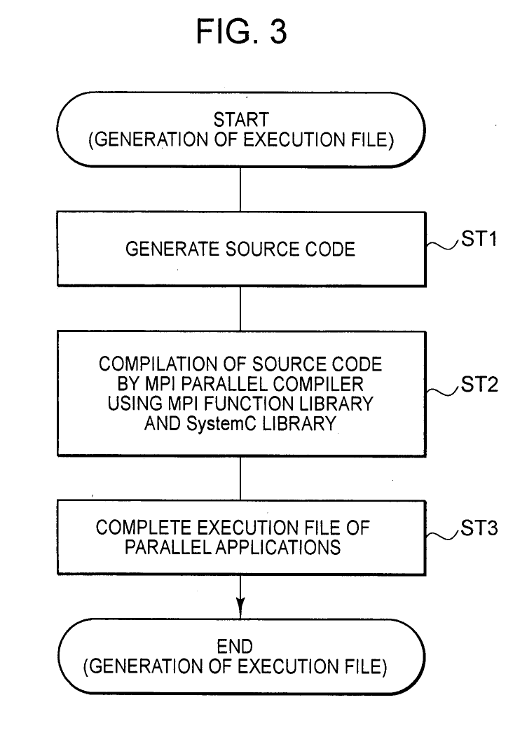

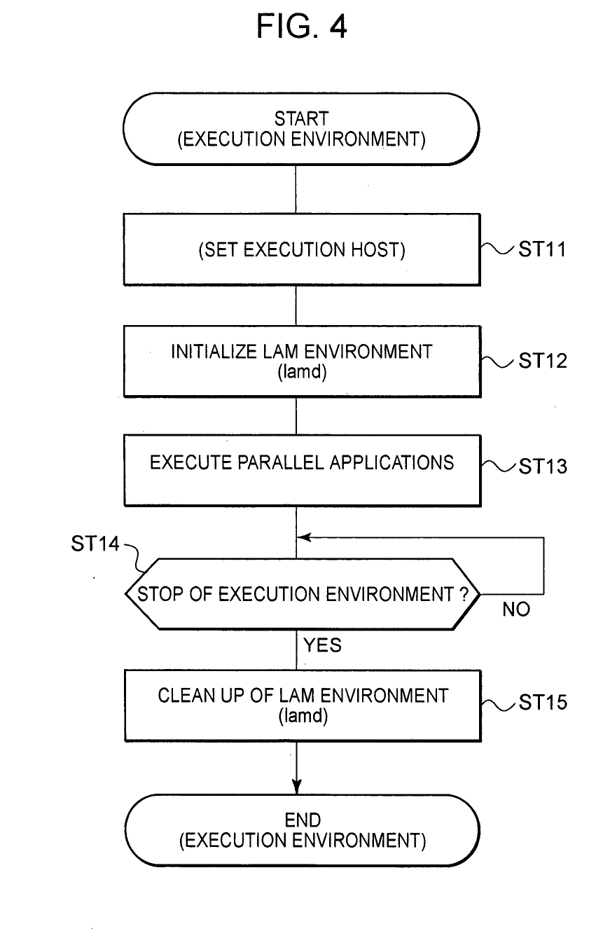

With reference to FIGS. 3 and 4, description will be made on generation of an execution file and activation of the execution environment to be executed by the software block 12 constructed as above. FIG. 3 is a flow chart illustrating a procedure of generating an execution file to be executed by the software block 12. FIG. 4 is a flow chart illustrating an execution environment activation procedure to be executed by the software block 12

In the process of generating an execution file, the source code generation part 121 generates source code of an MPI version (ST1). The generated source code is compiled by the MPI parallel compiler 122 while referring to the MPI function library 124 and SystemC library 125 (ST2). By using the compile results, the simulation execution form part 123 completes an execution file of parallel applications (ST3). The completed file is passed to the operating system 12C.

In the execution environment activation process, an execution host is set (ST11), and the environment of the resident program part 128 is initialized (ST12). Parallel applications are executed in accordance with the execution file generated by the execution file generation process (ST13). After execution, if the execution environment stops (ST14), the environment of the residual program part 128 is cleaned up (ST15).

The hardware block 13 has the nodes ND4 to ND7 including a plurality of circuit blocks including processor blocks. The nodes ND4 to ND7 each may have a CPU as a processing device and a hardware (H/W) block. In the example shown in FIG. 2, the node ND4 has one CPU 41, the node ND5 has two CPU's 51 and 52, the node ND6 has two CPU's 61 and 62, and the node ND7 has four CPU's 71 to 74.

The structure of each node will be described. The node ND1 of the integrated control block 11, the nodes ND2 and ND3 of the software block 12, and the nodes ND4 to ND7 of the hardware block 13 have similar structures, and only the node ND 8 of the storage apparatus 14 has a different structure.

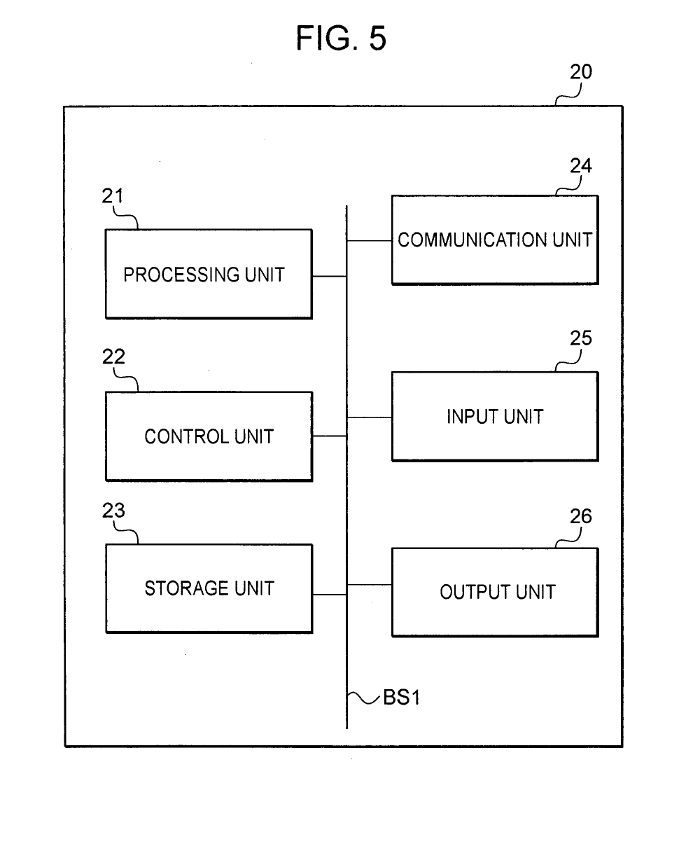

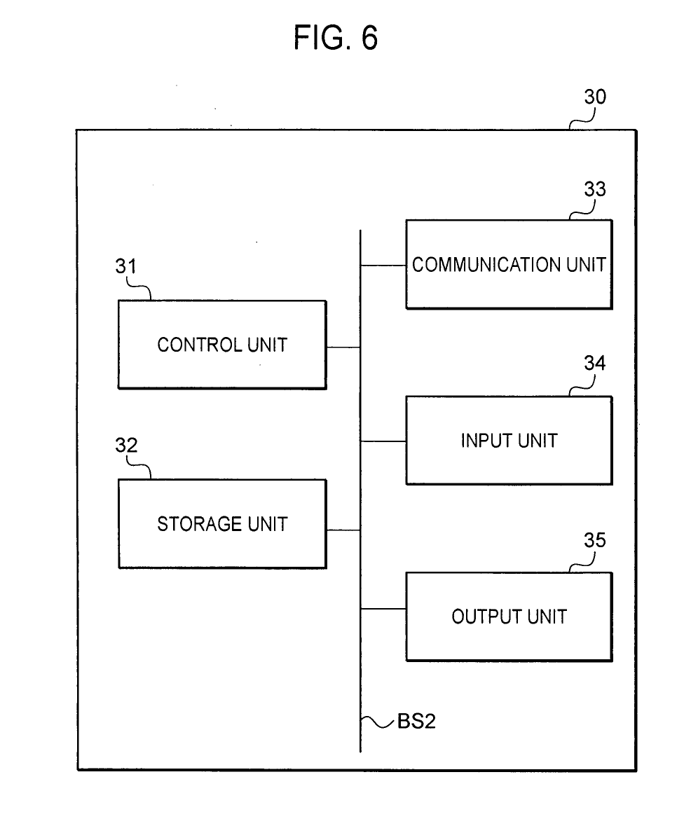

FIG. 5 is a block diagram showing an example of the structure of a first node of each block excluding the storage apparatus. FIG. 6 is a block diagram showing an example of the structure of a second node of the storage apparatus.

As shown in FIG. 5, the first node 20 has a processing unit 21, a control unit 22, a storage unit 23, a communication unit 24, an input unit 25 and an output unit 26, respectively interconnected by a bus BS1. In the structure shown in FIG. 5, for example, the processing unit 21 and control unit 22 of the first node 20 form a CPU.

As shown in FIG. 6, the second node 30 has a control unit 31, a storage unit 32, a communication unit 33, an input unit 34 and an output unit 35, respectively connected by a bus BS2.

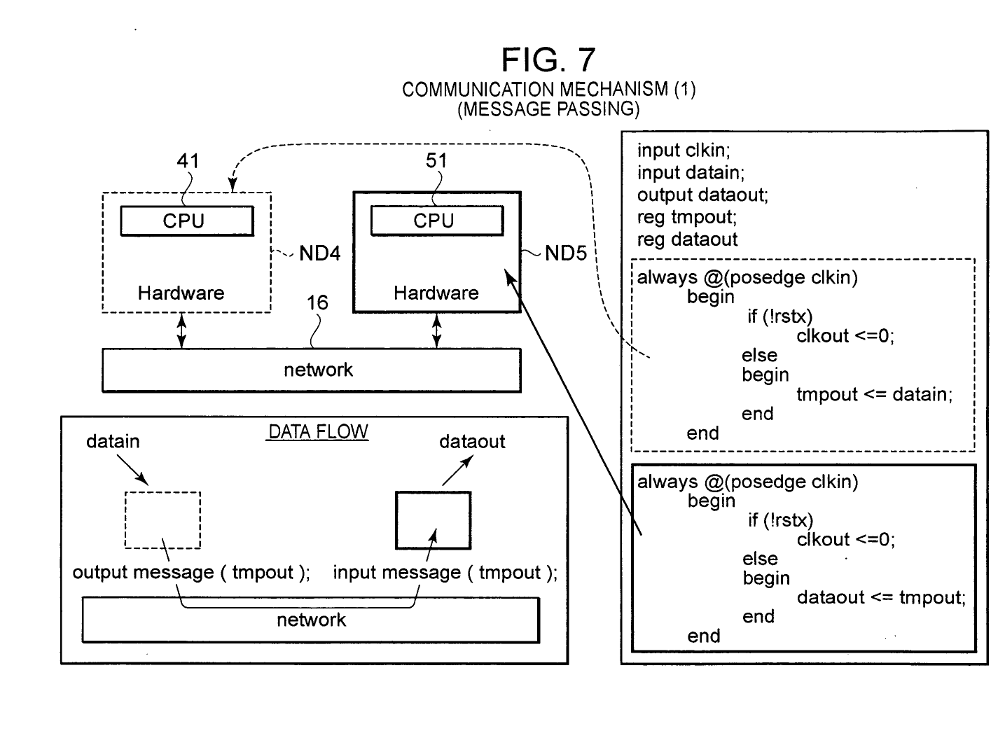

FIG. 7 is a diagram showing an example of data communications between two nodes (at a hardware level) by using a generated execution file.

The example shown in FIG. 7 illustrates message passing. The node ND4 inputs data to input an output message from the node ND4 to the node ND5 via the network 16, and the node ND5 outputs desired data after a predetermined process.

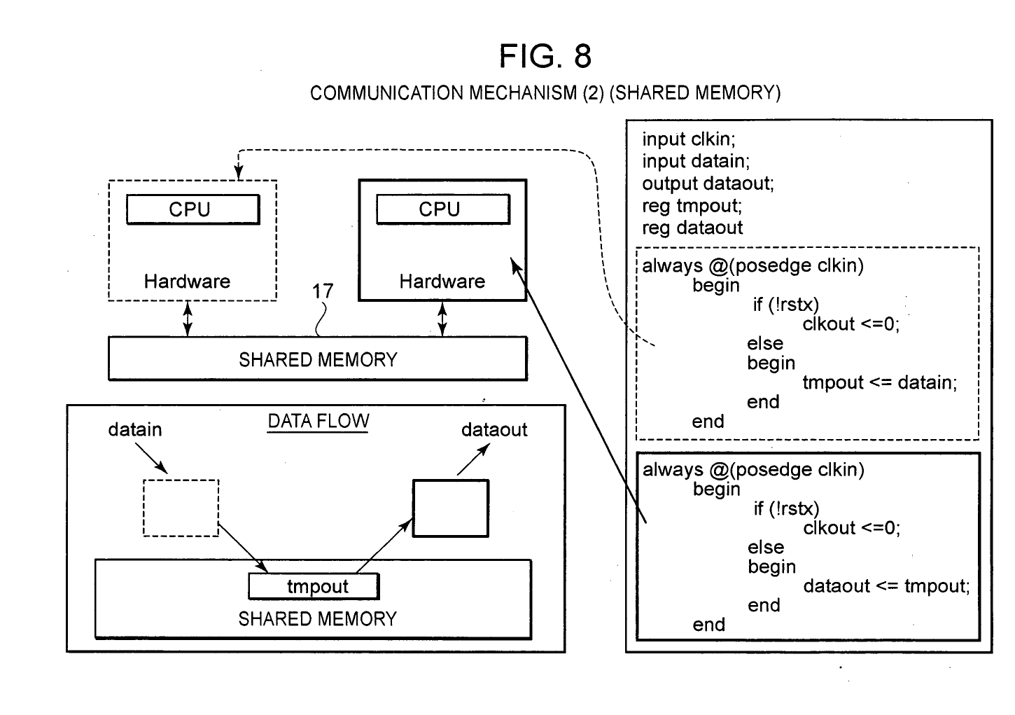

FIG. 8 is a diagram showing an example of data transfer between two nodes (at a hardware level) by using a generated execution file.

The example shown in FIG. 8 uses a shared memory 17 in place of the network. The node ND4 stores data (e.g. coefficients or the like) after the process by the node ND4 in the shared memory 17, and the node ND5 reads the data stored in the shared memory 17 and outputs desired data after a predetermined process.

In a hardware/software cooperative simulation execution environment in which each block is processed in parallel on a different CPU for simulation execution, the information processing apparatus 10 having the above-described configuration has the following three characteristic functions:

(A): “When new software is activated, it is checked whether another software has already been executed”,

(B): “if the other software is under execution, the simulation environment of the hardware block is copied”, and

(C): “the new software block is connected to the copied simulation environment of the hardware block to thereafter start simulation”.

As to (A):

There is a case in which it is checked simply whether another software is under execution. Generally, when a plurality of different ones of software which cannot be executed at the same time are to be executed, it is checked whether another of the same software is under execution.

As to (B):

“Copying the simulation environment of hardware” itself is a characteristic feature and not provided in a typical system.

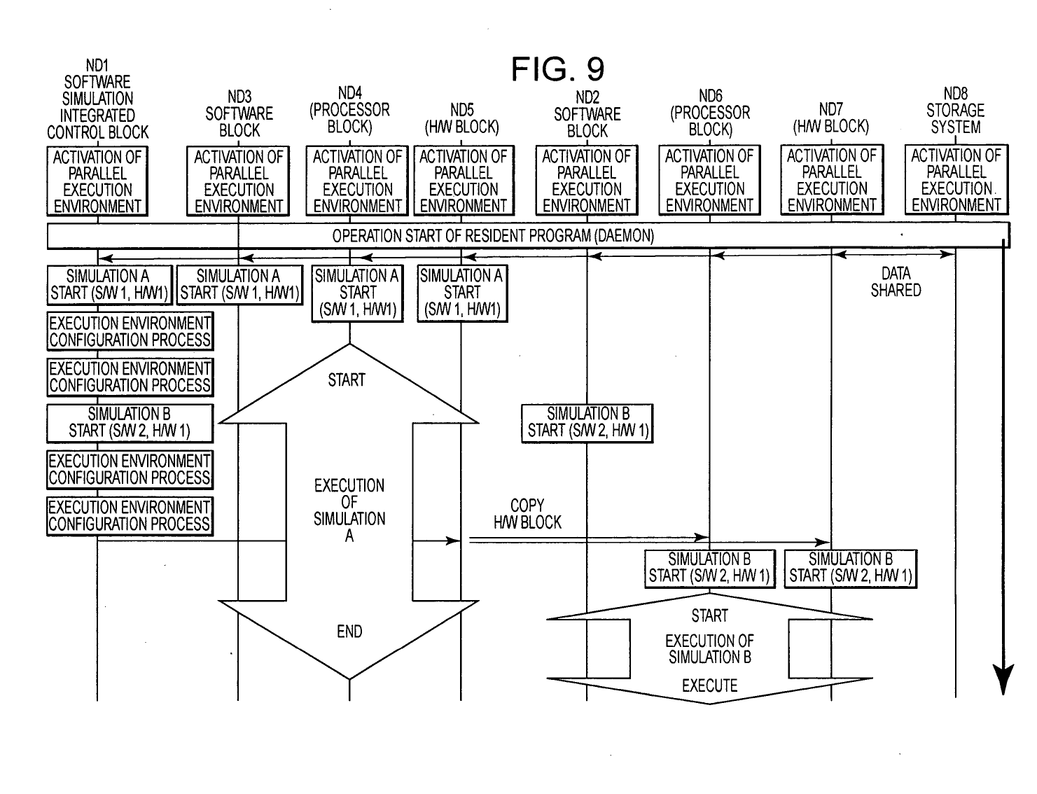

Description will be made on a typical sequence based upon these characteristic functions. FIG. 9 is a diagram showing an example of a typical sequence in the system of this embodiment. In FIG. 9, the nodes ND4, ND5, ND6 and ND7 of the hardware block 13 are shown as a processor block, a hardware (H/W) block, a processor block and a hardware (H/W) block, respectively.

In this embodiment, as described earlier, the system is adaptive for the parallel cooperative simulation execution environment, has the hardware block 13 having a plurality of circuit blocks including processor blocks, the software block 12 for accommodating and executing programs for software execution, and the integrated control block 11 for integrated control for the whole system, and executes, for example, the following processes in the hardware/software cooperative simulation execution environment in which each block is processed in parallel on a different CPU for simulation execution.

The node ND1, which executes simulation of the processor blocks, receives, via message passing communications, command code of an execution program from processes executed on the nodes ND2 and ND3 which execute simulation of the software block 12.

The integrated control block 11 dynamically controls and manages the cooperative simulation execution environment in accordance with the state of resources of the cooperative simulation execution environment and the execution content of the software block 12.

If the contents of a software block to be activated while another software block is being executed (first simulation A) are different from the other software block, the integrated control block 11 designates a configuration formed with a copy block obtained by copying a plurality of circuit blocks including processor blocks and its own software block and another node as simulation resources, and executes a second simulation (simulation B) at the other node of the system.

If the contents of a software block to be activated while another software block is being executed (first simulation A) are the contents following the contents of the other software block, the integrated control block 11 monitors the execution state of the other software block, and when an execution completion is detected, executes its own software block (second simulation B).

In the system of the embodiment, the processor block communicates with the software block which simulates software through message passing to thereby fetch execution code and execute simulation by using the fetched code.

The node of the software block 12, which executes simulation, is subjected to integrated control by the integrated control block 11 which activates and deactivates simulation code dynamically.

Blocks other than the software block 12 execute a copy and termination control for the simulation system at a repetition frequency corresponding to the number of activations.

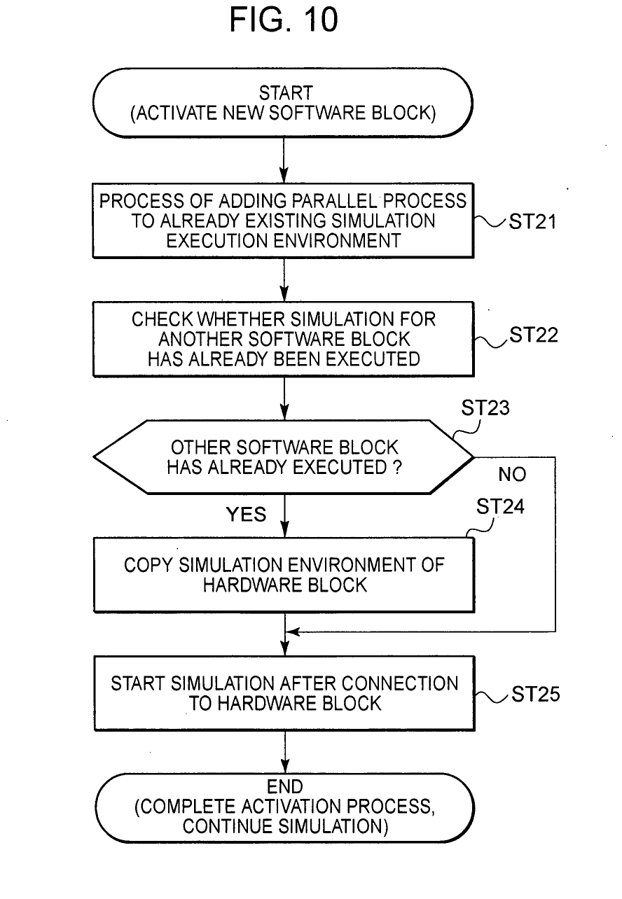

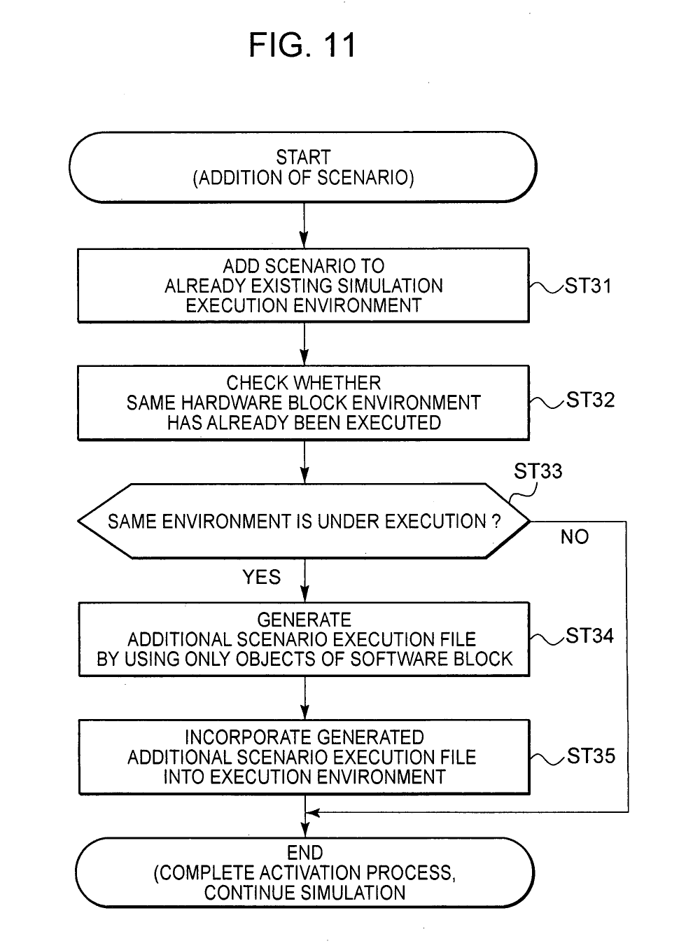

Next, with reference to FIGS. 10 and 11, description will be made on a control process for activation/termination of the software block to be executed by the integrated control block 11. FIG. 10 is a flow chart illustrating a software activation/termination control procedure by an integrated control block when a new software block is activated. FIG. 11 is a flow chart illustrating a software activation/termination control procedure by the integrated control block when another scenario is to be added after a software block has been activated.

First, with reference to FIG. 10, description will be made on a software block activation/termination control procedure to be executed by the integrated control block when a new software block is to be activated.

In the execution environment already executing simulation including the software block and hardware block, if relevant simulation is to be executed in succession, a process is executed for adding a parallel process (ST21).

It is checked whether simulation of another software block has already been executed, in other words, whether there exists another simulation including the same hardware block now under execution (ST22, ST23).

If another simulation is under execution, the simulation environment of the hardware block is copied to the new node configuration in the parallel execution environment (ST24).

After the process at Step ST24 or if it is judged at Step ST23 that there exists another simulation under execution, the copied simulation environment of the hardware block is connected to the simulation environment of the new software block to execute simulation (ST25).

In this manner, the activation process is terminated and simulation continues.

Next, with reference to FIG. 11, description will be made on a software block activation/termination control procedure to be executed by the integrated control block when another scenario is to be activated.

In this case, a scenario is added to the already existing simulation execution environment (ST31). Next, it is checked whether there exists the same hardware block environment already executed (ST32, ST33). If there exists the same hardware block environment already executed, an additional scenario execution file is generated by using only the objects of the software block 12 (ST34). The generated additional scenario execution file is incorporated into the execution environment (ST35). After the process at Step S35 or if it is judged at Step S33 than the same hardware block environment is not executed, the activation process is terminated and simulation continues.

A process of adding a scenario will be described in connection with a specific example.

Example of Scenario:

Description will be made by using embedded software for controlling a DVD recorder of an HDD built-in type by way of example.

Outline of Scenario:

Initial Scenario: An already existing scenario which includes turning on a power source of a DVD recorder, after activation, selecting an already recorded program from a menu, and playing the program. Additional Scenario: A case in which while playing the program in the initial scenario, a record reservation menu is called, and a record date/time and a channel are registered to resume playing the program. An object of the additional scenario is to check whether the function of temporarily pausing the play during the record reservation can operate normally.

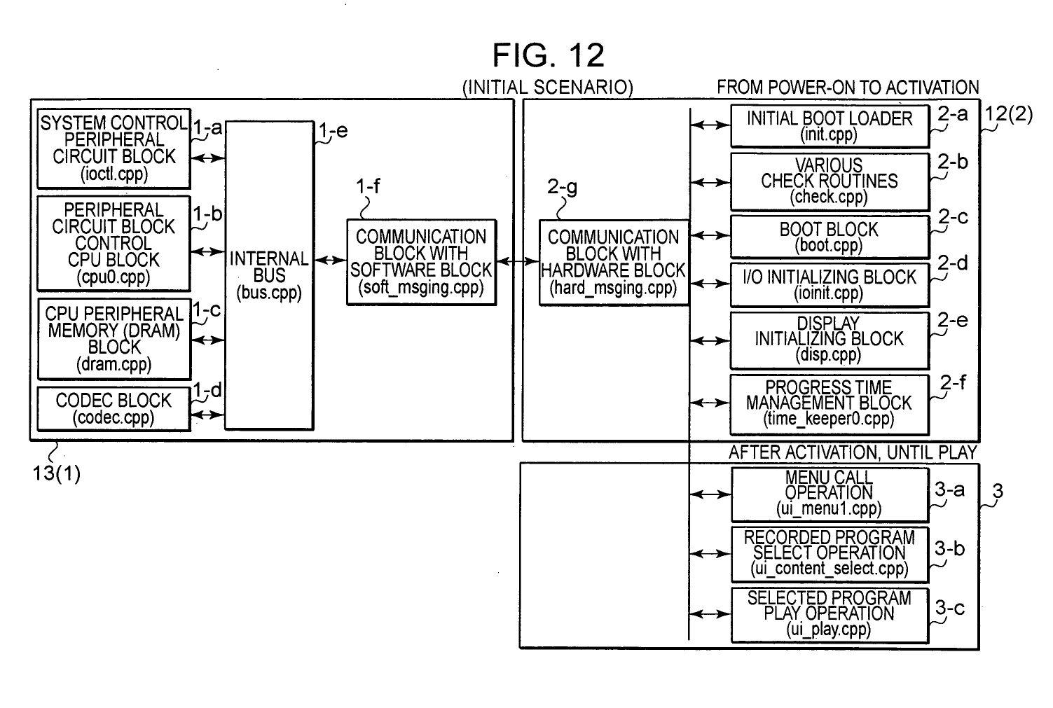

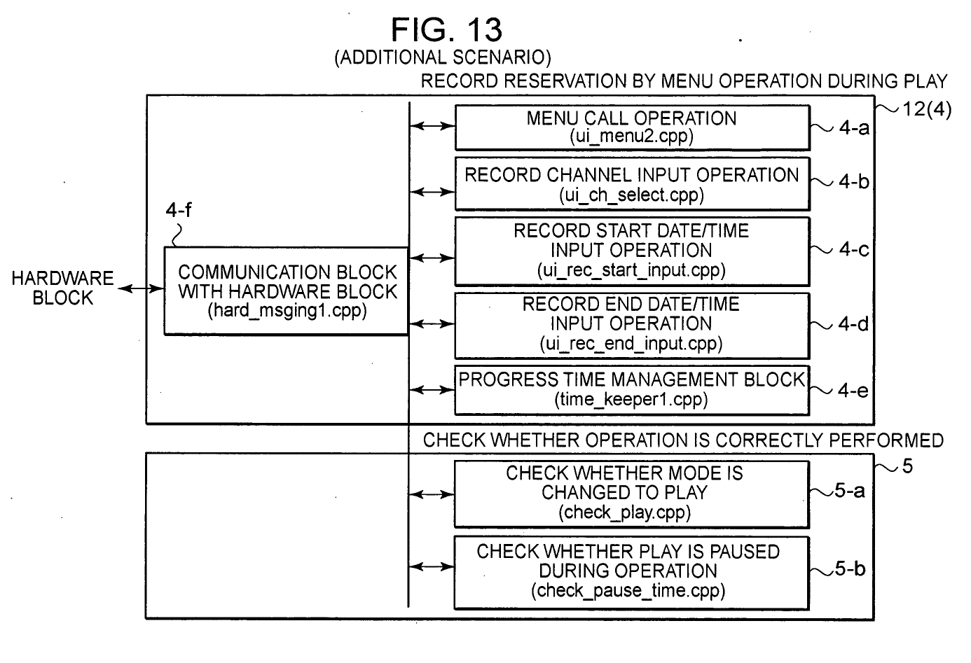

FIG. 12 is a block diagram showing an example of the structure of a hardware block and a software block, during the initial scenario. FIG. 13 is a block diagram showing an example of the structure of a software block during the additional scenario.

Initial Scenario Configuration:

The hardware block 13 and the software block 12 have the initial scenario configuration such as shown in FIG. 12 and described in the following. In the following, in order to make it easy to understand, the configuration is enumerated through itemization.

1. Hardware block 13:
1-a: system control peripheral circuit block, name: ioctrl.cpp
1-b: peripheral circuit block control CPU block, name: cpu0.cpp
1-c: CPU external memory (DRAM) block, name: dram.cpp
1-d: codec block, name: codec.cpp
1-e: internal bus, name: bus.cpp
1-f: communication block with software block, name: soft_msging.cpp

2. Software block: (power-on to activation)
2-a: initial boot loader, name: init.cpp
2-b: various check routines, name: check.cpp
2-c: boot block, name: boot.cpp
2-d: I/O initializing block, name: ioinit.cpp
2-e: display initializing block, name: disp.cpp
2-f: communication block with hardware block, name: hard_msging.cpp
2-g: progress time management block, name: time_keeper0.cpp

3. Software block: (after activation, until play)
3-a: menu call operation, name: ui_menu1.cpp
3-b: recorded program select operation, name: ui_content_select.cpp
3-c: selected program play operation, name: ui_play.cpp
   Additional Scenario Configuration:

The hardware block 13 and the software block 12 have the initial scenario configuration such as shown in FIG. 12 and described in the following. In the following, in order to make it easy to understand, the configuration is enumerated through itemization.

4. Software block: (record reservation by menu operation during play)
4-a: menu call operation, name: ui_menu2.cpp
4-b: record channel input operation, name: ui_ch_select.cpp
4-c: record start date/time input operation, name: ui_rec_start_input.cpp
4-d: record end date/time input operation, name: ui_rec_end_input.cpp
4-e: communication block with hardware block, name: hard_msging1.cpp
4-f: progress time management block, name: time_keeper1.cpp

5. Software block: (check whether operation is correctly performed)
5-a: check whether mode is changed to play, name: check_play.cpp
5-b: check whether play is temporarily paused during operation, name: check_pause_time.cpp

At the activation stage, objects obtained as the results of compiling each of source code of ioctl.cpp, cpu0.cpp, dram.cpp, codec.cpp and bus.cpp for the hardware environment are linked to objects obtained as the results of compiling each of source code of init.cpp, check.cpp, boot.cpp, ioinit.cpp, disp.cpp, ui_menu1.cpp, ui_content_select.cpp and ui_play.cpp for the software environment, to generate an execution file and enter the parallel execution environment.

The hardware block and software block communicate by a process corresponding to each of source code of soft_msging.cpp and hard_msging.cpp to perform the operations of the whole system.

In the parallel execution environment, a node group for executing a plurality of hardware blocks 1-a to 1-e is constituted of a node group different from a node group for executing the software blocks 2-a to 3-c.

It is assumed that hardware block execution nodes ws_hard0, ws_hard1, ws_hard2, ws_hard3 and ws_hard4 are executed in parallel.

Correspondence between execution node and block:
ws_hard0: ioctrl.cpp
ws_hard1: cpu0.cpp
ws_hard2: dram.cpp
ws_hard3: codec.cpp
ws_hard4: bus.cpp
ws_hard5: soft_masging.cpp

It is assumed that execution nodes ws_soft0, ws_soft1, ws_soft2, ws_soft3, ws_soft4, ws_soft5, ws_soft6, ws_soft7 and ws_soft8 are executed in parallel.

Correspondence between execution node and block:
ws_soft0: init.cpp
   ws_soft1: check.cpp
ws_soft2: boot.cpp
   ws_soft3: ioinit.cpp
ws_soft4: disp.cpp
   ws_soft5: hard_msging.cpp, time_keeper0.cpp
   ws_soft6: ui_menu1.cpp
ws_soft7: ui_content_select.cpp
   ws_soft8: ui_play.cpp

At this stage, the initial scenario is executed to progress a cooperative parallel execution process for the hardware and software (initial scenario).

Next, the additional scenario is entered. The hardware blocks correspond to the same object as those used by the initial scenario obtained as the results of compiling each of source code of ioctl.cpp, cpu0.cpp, dram.cpp, codec.cpp and bus.cpp.

The software blocks of the additional scenario correspond to objects obtained as the results of compiling each of source code of ui_menu2.cpp, ui_ch_select.cpp, ui_rec_start_input.cpp, ui_rec_end_input.cpp, hard_msging1.cpp, time_keeper1.cpp, and in addition, check_play.cpp and check_pause_time.cpp for operation check.

In a link process for hardware and software, the parallel execution environment now under execution is checked, if the same environment as the environment of the hardware block is now under execution, an execution file is generated by using objects of only the software block, and the generated execution environment is incorporated into the parallel execution environment. These processes correspond to those shown in the flow chart of FIG. 11.

It is assumed that software block execution nodes ws_soft9, ws_soft10, ws_soft2, ws_soft3, ws_soft4, ws_soft5, ws_soft6, ws_soft7 and ws_soft8 are executed in parallel.

Correspondence between execution node and block:
ws_soft9: check_play.cpp
ws_soft10: check_pause_time.cpp

If not the additional scenario but quite a new scenario is to be executed on the same hardware block, this scenario is executed by copying the environment of each node of the hardware block to another node.

The following advantages can be obtained by adding a scenario to the simulation now under execution or dynamically configuring a new execution environment.

Simulation for an LSI can realize function verification, quality improvement and TAT reduction, by executing a number of scenarios and verifying all of the scenarios. Accordingly, in order to improve coverage while completing the generated scenario, later creation and/or addition of a new scenario, and merging of a scenario with the simulation now under execution. Accordingly, the is very effective for quality improvement of LSI and design TAT reduction.

As described so far, the embodiment has the following characteristic configuration, in the hardware/software cooperative simulation execution environment in which each block is processed in parallel on a different CPU for simulation execution, and in the system having a plurality of circuit blocks including processor blocks, the software block for accommodating and executing programs for software execution, and the integrated control block for integrated control for the whole system.

Namely, the node ND1 which executes simulation of the processor blocks, receives, via message passing communications, command code of an execution program from a processes executed on the node ND2 which executes simulation of the software block 12. The integrated control block dynamically controls and manages the cooperative simulation execution environment in accordance with the state of resources of the cooperative simulation execution environment and the execution content of the software block. If the contents of a software block to be activated while another software block is being executed (first simulation A) are different from the other software block, the integrated control block 11 designates a configuration formed with a copy block obtained by copying a plurality of circuit blocks including processor blocks and its own software block, and another node as simulation resources to thereafter execute a second simulation (simulation B) at the other node of the system. If the contents of a software block to be activated while another software block is being executed (first simulation A) are the contents following the contents of the other software block, the integrated control block monitors the execution state of the other software block, and when an execution completion is detected, executes its own software block (second simulation B). With this arrangement, the following advantage is therefore obtained.

In the simulation of hardware and software now under execution, if relevant simulation is to be executed in succession, this simulation can be executed by adding new code. On the other hand, if irrelevant simulation is to be executed in the same hardware environment including processors, this simulation can be executed by using software code for new simulation and the hardware environment using another node. Therefore, it is possible to reduce a design turnaround time (TAT) considerably.

This advantage will be described more concretely.

For a parallel execution program for EDA simulation of software and hardware blocks of a related art system, it is necessary that a full simulation scenario is first created, coded, compiled and executed (A). If a scenario is to be added, it is necessary that the scenario is coded, compiled and executed (B).

If TA is 10 hours and TB is 12 hours, where TA (Time for A) is a time taken to execute (A) and TB (Time for B) is a time taken to execute (B), for a typical system it takes 8+12=20 hours if TB starts during the TA execution after 8 hours from the start of TA (a first execution example), and it takes 10+12=22 hours if the TB execution starts after TA (a second execution example). An additional time TC of TB adding a scenario to TA is 2 hours.

In this embodiment, TB′, which is a copy of TB, is executed during the TA execution, simulation for the additional 2 hours is executed after the TA execution so that the total simulation is completed by 12 hours in total.

Namely, TAT of a typical system is 20 hours for the first execution example, and 22 hours for the second execution example. In contrast, TAT of the information processing apparatus of the embodiment of the present invention is 12 hours.

Since 12/20=60% for the first execution example, TAT is improved by 40%. Since 12/22=55% for the second execution example, TAT is improved by 45%.

The present embodiment is applicable to adding a scenario to reconfigurable hardware.

The present embodiment provides a flexible development environment for performing dynamic simulation execution environment control and can improve a development efficiency, in performing simulation of hardware including processor blocks and software, e.g. spice simulation of an analog circuit, in a semiconductor development/design environment.

The present document contains subject matter related to Japanese Patent Application No. 2006-192661 filed in the Japanese Patent Office on Jul. 13, 2006, the entire content of which being incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus for performing information processing in a cooperative simulation execution environment for executing simulation of hardware and software by processing each block on a different processor, the information processing apparatus comprising:
a plurality of circuit blocks including processor blocks;
a software block accommodating and executing programs for executing software; and
an integrated control block performing integrated control of the whole system, wherein:
the processor block fetches execution code from the software block for simulating software, via message passing communications, and executes simulation in accordance with the execution code; and
the integrated control block controls in such a manner that
a node executing simulation of the software block dynamically activates and deactivates simulation code as necessity arises,
when new software is to be activated, the integrated control block controls to check whether another software has already been executed,
if the other software is under execution, the integrated control block copies a simulation environment of a hardware block, connects the new software block to the copied simulation environment of the hardware block, and starts simulation.

2. The information processing apparatus according to claim 1, wherein
the integrated control block performs copy and termination control of a simulation system at a repetition frequency corresponding to a number of activations, for the hardware block other than the software block.

3. The information processing apparatus according to claim 1, wherein:
the node for executing simulation of the processor block receives, via message passing communications, command code of an execution program from a process executed at a node for executing simulation of the software block; and
the integrated control block dynamically controls and manages a configuration of an execution environment in accordance with a state of resources of the cooperative simulation execution environment and execution content of the software block.

4. The information processing apparatus according to claim 3, wherein
if content of a software block is different from the other software block and is to be activated while a first simulation of another software block is being executed, the integrated control block designates a configuration formed with a copy block obtained by copying a plurality of circuit blocks including processor blocks and its own software block and another node as simulation resources, and controls to execute a second simulation at the another node of the system.

5. The information processing apparatus according to claim 4, wherein
if the content of the software block is activated while the first simulation of the other software block is being executed and is content following the content of the other software block, the integrated control block controls to monitor an execution state of the other software block, and to execute the second simulation of its own software block when an execution completion is detected.

6. An information processing apparatus for performing information processing in a cooperative simulation execution environment for executing simulation of hardware and software by processing each block on a different processor, the information processing apparatus comprising:
a plurality of circuit blocks including processor blocks;
a software block accommodating and executing programs for executing software; and
an integrated control block performing integrated control of the whole system, wherein:
a node executing simulation of the processor block receives, via message passing communications, command code of execution program from a process executed at a node executing simulation of the software block; and
the integrated control block:
dynamically controls and manages a configuration of the execution environment in accordance with a state of resources of the cooperative simulation execution environment and execution content of the software block;
if content of a software block to be activated while a first simulation of another software block is being executed is different from the other software block, designates a configuration formed with a copy block obtained by copying a plurality of circuit blocks including processor blocks and its own software block and another node as simulation resources, and executes a second simulation at the another node of the system; and
if the content of the software block to be activated while the first simulation of the other software block is being executed is content following the content of the other software block, controls to monitor an execution state of the other software block, and when an execution completion is detected, executes the second simulation of its own software block.

7. An information processing method of performing information processing in an cooperative simulation execution environment for executing simulation of hardware and software by processing each block on a different processor, by using a plurality of circuit blocks including processor blocks and a software block accommodating and executing programs for executing software, the information processing method comprising:
executing simulation in accordance with execution code obtained by fetching the execution code from the software block for simulating software, via message passing communications, by the processor block;
controlling a node for executing simulation of the software block so as to dynamically activate and deactivate simulation code as necessity arises;
checking whether another software has already been executed if new software is to be activate;
copying a simulation environment of a hardware block if the other software is under execution; and
starting simulation by connecting the new software block to the copied simulation environment of the hardware block.

8. An information processing method of performing information processing in a cooperative simulation execution environment for executing simulation of hardware and software by processing each block on a different processor, by using a plurality of circuit blocks including processor blocks and a software block accommodating and executing programs for executing software, the information processing method comprising:
receiving, by a node for executing simulation of the processor block, command code of execution program from a process executed at a second node for executing simulation of the software block, via message passing communications;
dynamically controlling and managing a configuration of the execution environment in accordance with a state of resources of the cooperative simulation execution environment and execution content of the software block;
designating a configuration formed with a copy block obtained by copying a plurality of circuit blocks including processor blocks and its own software block, and another node as simulation resources, if content of a software block to be activated while a first simulation of another software block is being executed is different from the other software block;
executing a second simulation at the another node of the system; and
monitoring an execution state of the other software block and executing the second simulation of its own software block upon detection of an execution completion if the content of the software block to be activated while the first simulation of the other software block is being executed is content following the content of the other software block.
